(19) United States
(12) Patent Application Publication
(10) Pub. No.: US 2007/0292679 A1
(43) Pub. Date: Dec. 20, 2007

(54) OPTICAL ARTICLE HAVING AN ANTISTATIC FLUOROCHEMICAL SURFACE LAYER

(75) Inventors: Mark J. Pellerite, Woodbury, MN (US); Christopher B. Walker, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/758,250

(22) Filed: Jun. 5, 2007

Related U.S. Application Data
(60) Provisional application No. 60/804,774, filed on Jun. 14, 2006.

(51) Int. Cl. B32B 27/30; B32B 27/20

(52) U.S. Cl. 428/328; 428/421; 428/336; 428/522

(57) ABSTRACT

Disclosed herein is an optical article having: (a) a light transmissive substrate; (b) a hardcoat layer disposed on the light transmissive substrate and including a (meth)acrylate-functionalized metal oxide having an average particle size of less than about 100 nm, and a multifunctional (meth)acrylate monomer; and (c) a fluorochemical surface layer disposed on the hardcoat layer opposite the light transmissive substrate and including a fluorinated (meth)acryl monomer, a non-fluorinated crosslinking agent, and from about 25 to about 60 wt. % of conducting metal oxide nanoparticles, wherein the fluorochemical surface layer exhibits little or no color change with respect to the fluorochemical surface layer without the nanoparticles.

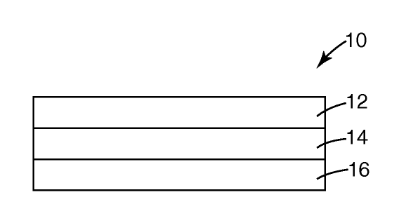

### CROSS REFERENCE TO RELATED APPLICATION

This application claims the benefit of U.S. Provisional Application No. 60/804774, filed Jun. 14, 2006, the disclosure of which is incorporated herein by reference.

### BACKGROUND

An optical article useful for protecting the exposed viewing surface of a display device is disclosed herein. The optical article has an antistatic fluorochemical surface layer comprising conductive metal oxide nanoparticles.

Optical display devices are ubiquitously present in today's society and include handheld devices such as cell phones and personal digital assistants, as well as televisions, computers, and various touch screen devices such as ATM machines. The exposed viewing surface of a display device often comprises a film or slab of some material having a desired degree of optical transmissivity and clarity, but most often this surface is easily damaged due to scratching or contact with solvents. The exposed viewing surface is also easily smudged with a variety of substances such as skin oils and food products in the course of routine handling; for example, a user's facial oils can adversely affect contrast, color saturation or brightness of a cell phone display. Over time, the exposed viewing surface may become so damaged as to render the display device unreadable or inoperative.

It is therefore desirable to provide a display device having an exposed display surface that exhibits improved resistance to physical and chemical abuse. Ideally, the surface would be hard enough to resist scratching yet be easily cleaned of dirt, oils, food, etc. It is also important that the exposed display surface be able to dissipate static charge so that dust and various other debris are not attracted to, or at least easily removed from, the surface as this can lead to unwanted optical artifacts that may detract from the user's viewing experience.

### SUMMARY

In one aspect, disclosed herein is an optical article comprising: (a) a light transmissive substrate; (b) a hardcoat layer disposed on the light transmissive substrate, the hardcoat layer comprising: a (meth)acrylate-functionalized metal oxide having an average particle size of less than about 100 nm, and a multifunctional (meth)acrylate monomer; and (c) a fluorochemical surface layer disposed on the hardcoat layer opposite the light transmissive substrate, the fluorochemical surface layer comprising: a fluorinated (meth)acryl monomer, a non-fluorinated crosslinking agent, and from about 25 to about 60 wt. % of conducting metal oxide nanoparticles, wherein the fluorochemical surface layer exhibits little or no color change with respect to the fluorochemical surface layer without the nanoparticles.

In another aspect, disclosed herein is a display device comprising: a light source; a display panel; and an optical article disposed on the display panel on the side opposite the light source, the optical article comprising: (a) a light transmissive substrate; (b) a hardcoat layer disposed on the light transmissive substrate, the hardcoat layer comprising: a (meth)acrylate-functionalized metal oxide having an average particle size of less than about 100 nm, and a multifunctional (meth)acrylate monomer; and (c) a fluorochemical surface layer disposed on the hardcoat layer opposite the light transmissive substrate, the fluorochemical surface layer comprising: a fluorinated (meth)acryl monomer, a non-fluorinated crosslinking agent, and from about 25 to about 60 wt. % of conducting metal oxide nanoparticles, wherein the fluorochemical surface layer exhibits little or no color change with respect to the fluorochemical surface layer without the nanoparticles; wherein the light transmissive substrate is adjacent the display panel.

These and other aspects of the invention will be apparent from the detailed description and accompanying figure. In no event should the above summary be construed as a limitation on the claimed subject matter, which subject matter is defined solely by the claims, as may be amended during prosecution.

### BRIEF DESCRIPTION OF DRAWING

The FIGURE shows an exemplary optical article.

### DETAILED DESCRIPTION

The optical article disclosed herein may be described as a protective article suitable for use in optical applications in which light is managed, enhanced, manipulated, controlled, maintained, transmitted, reflected, refracted, absorbed, etc. The optical article may be used in a graphic arts application, for example, backlit signs, billboards, and the like. The optical article may be used in a display device comprising, at the very least, a light source and a display panel. In this case, the optical article may be positioned over the display panel, opposite the light source, such that the fluorochemical surface layer is exposed and the light transmissive substrate is adjacent the display panel. The display panel may be of any type capable of producing images, graphics, text, etc., and may be mono- or polychromatic. Examples include a liquid crystal display panel, a plasma display panel, or a touch screen. The light sources may comprise fluorescent lamps, phosphorescent lights, light emitting diodes, or combinations thereof. Examples of display devices include televisions, monitors, laptop computers, and handheld devices such as cell phones, PDA's, calculators, and the like.

The optical article disclosed herein provides numerous advantages. The optical article provides protection from everyday physical and chemical abuse without interfering with the optical characteristics of the display. The surface of the optical article is generally hard enough to resist scratching yet it can be easily cleaned of dirt, oils, food, etc. In addition, the surface of the optical article has a low enough surface energy such that it exhibits ink repellency and ink bead up. Unexpectedly, it has been found that conducting nanoparticles can be incorporated into the fluorochemical surface layer in amounts sufficient to impart the desired antistatic properties to the article without negatively impacting the hardness and surface energy of the article. The optical article is also designed to exhibit minimum haze and maximum light transmission properties.

The optical article provides additional advantages by being antistatic without the need for circuitry (e.g., wires) connected to one or more surfaces of the article. An exemplary article exhibits sufficient antistatic properties so as to minimize dust, dirt, and other particles from adhering to the surface of the optical article. The optical article can exhibit high resistivity values, e.g., greater than about 1×10⁸ ohms/sq or greater than about 1×10¹⁰, yet sustain effective antistatic properties. In addition, the optical article disclosed herein may exhibit static decay times of less than about 2 seconds, for example, less than 0.01 seconds.

For clarity, it is noted that although the term “conductive” is often used in the industry to refer to “static dissipative”, i.e., antistatic, the terms conductive and antistatic as used herein are not intended to be synonymous. Specifically, a conductive material coating is considered to have a surface resistivity up to 1×10⁵ ohms/sq, whereas an antistatic material coating typically has a surface resistivity up to 1×10¹² ohms/sq. These terms are generally used to describe materials having a conductive or antistatic component or agent on an exposed surface of the material. (In comparison, an optical article can be antistatic by having an antistatic layer “buried” between optical layers having no antistatic properties, even though the article would exhibit higher levels of surface resistivity.) Furthermore, static decay times can be maintained for the optical article even with these high surface resistivity values.

The FIGURE shows exemplary optical article 10 having fluorochemical surface layer 12, hardcoat layer 14, and light transmissive substrate 16. As described above, the fluorochemical surface layer comprise a fluorinated (meth)acryl monomer, a non-fluorinated crosslinking agent, and conducting metal oxide nanoparticles, wherein the fluorochemical surface layer exhibits little or no color change with respect to the fluorochemical surface layer without the nanoparticles. The formulations used to form the fluorochemical surface layer overcome problems associated with fluorochemicals and antistats in which fluorochemicals migrate to the surface over time and are water repellent, and antistats go to the surface and are water absorbing. Thus, these two components can be combined into a single formulation for coating which both simplifies and reduces manufacturing costs. The hardcoat layer comprises a (meth)acrylate-functionalized metal oxide having an average particle size of less than about 100 nm, and a multifunctional (meth)acrylate monomer.

The fluorochemical surface layer may be used to provide a surface that is easy to clean and/or has low enough surface energy such that it exhibits particular minimum static, advancing, and receding contact angles with water and minimum advancing and receding contact angles with hexadecane. The fluorochemical surface layer may be used with a hardcoat layer that does or does not contain a fluorinated (meth)acryl monomer. That is, the fluorochemical surface layer may be used to provide the required low energy surface or to improve the surface energy provided by the hardcoat layer. If used, the fluorochemical surface layer must not have an adverse effect on antistatic performance, static decay times, haze and light transmission properties of the optical article.

The fluorochemical surface layer comprises conducting metal oxide nanoparticles for antistatic properties. The particular nanoparticles used will depend on the thickness of the fluorochemical surface layer and the effectiveness of the nanoparticles as an antistat, as well as the desired antistat performance. In one example, the conducting metal oxide nanoparticles comprise antimony zinc oxide, antimony tin oxide, indium tin oxide, or combinations thereof. Other conducting metal oxide nanoparticles that may be used include vanadia, tin oxide, zinc oxide, or combinations thereof. The conducting metal oxide nanoparticles are employed at levels that preserve, to the naked eye, the color and percent transmission of the optical article. Typically, the nanoparticles comprise from about 25 to about 60 wt. % of the fluorochemical surface layer.

The fluorochemical surface layer also comprises a fluorinated (meth)acryl monomer in order to impart low surface energy to the surface of the optical article. Low surface energy is generally indicated by a surface exhibiting particular minimum static, advancing, and receding contact angles with water and minimum advancing and receding contact angles with hexadecane. For water, the static contact angle is at least 100, the advancing contact angle is at least 110, and the receding contact angle is at least 75. For hexadecane, the advancing contact angle is at least 60, and the receding contact angle is at least 50.

The fluorinated (meth)acryl monomer may be represented by Formula I:

R_{f}—(W—R_{A})_{w} (I)

wherein R_{f} comprises a perfluoropolyether group, W comprises a linking group, R_{A} comprises a (meth)acryl group or —COCF═CH₂, and w is 1 or 2. The perfluoropolyether group R_{f} can be linear, branched, cyclic, or combinations thereof and can be saturated or unsaturated. The perfluoropolyether group has at least two catenated oxygen heteroatoms. Exemplary perfluoropolyether groups include those having perfluorinated repeating units such as —(CₚF₂ₚ)—, —(CₚF₂ₚO)—, —(CF(Z))-, —(CF(Z)O)—, —(CF(Z)CₚF₂ₚO)—, —(CₚF₂ₚCF(Z)O)—, —(CF₂CF(Z)O)—, or combinations thereof. In these repeating units, p is typically an integer of from 1 to 10. The group Z comprises a perfluoroalkyl group, perfluoroether group, perfluoropolyether, or a perfluoroalkoxy group, all of which can be linear, branched, or cyclic. The Z group typically has no more than 12 carbon atoms and either no oxygen atoms or no more than 4 oxygen atoms.

R_{f} can be monovalent or divalent. For example, monovalent R_{f} groups include (CₚF₂ₚ₊₁O)—, (XCₚF₂ₚO)—, or (XCₚF₂ₚ₊₁)— wherein X comprises hydrogen, chlorine, or bromine, and p is an integer of 1 to 10. Exemplary monovalent R_{f} groups include CF₃O(C₂F₄O)ₙCF₂— and C₃F₇O(CF(CF₃)CF₂O)ₙCF(CF₃)— wherein n has an average value of from 0 to 50, from 3 to 30, or from 3 to 10. In one particular example, the R_{f} group comprises F(CF(CF₃)CF₂O)ₐCF(CF₃)— wherein a averages from 4 to 15; this group is referred to as HFPO. Exemplary divalent R_{f} groups include —CF₂O(CF₂O)_{q}(C₂F₄O)ₙCF₂—, —(CF₂)₃O(C₄F₈O)ₙ(CF₂)₃—, —CF₂O(C₂F₄O)ₙCF₂—, and ‘CF(CF₃)(OCF₂CF(CF₃))ₛOCₜF₂ₜO(CF(CF₃)CF₂O)ₙCF(CF₃)—, wherein each n, q and s has an average value of from 0 to 50, from 3 to 30, or from 3 to 10, with the provisos that the sum (n+s) has an average value of from 0 to 50 or from 4 to 40, and the sum (q+n) is greater than 0; and t is an integer of 2 to 6. The fluorinated (meth)acryl monomer may comprise a mixture of monomers having a mixture of R_{f} groups. As such, the values of q, n and s in these average structures can vary, as long as the fluorinated (meth)acryl monomer has a number average molecular weight of at least about 400, for example, from 800 to 4000.

The linking group W comprises a divalent group and may have alkylene, arylene, heteroalkylene, carbonyl, ester, amide, or sulfonamido functionality, or combinations thereof. Any of these groups may be unsubstituted or substituted, for example, with alkyl, aryl, or halogen groups, or combinations thereof. The W group typically has no more than 30 carbon atoms, for example, no more than 4 carbon atoms. For example, W can be an alkylene, an alkylene substituted with an aryl group, or an alkylene in combination with an arylene, alkyl ether, or alkyl thioether group. The group R_{A} may comprise a (meth)acryl group or —COCF═CH₂. The monomers of Formula I may be prepared as described in US 2006/0216524A1.

In another embodiment, the fluorinated (meth)acryl monomer may be represented by Formula II:

(HFPO)ₙQ₃Xₘ (II)

wherein n is from 1 to 3, Q₃ comprises a linking group, X comprises a free-radically reactive group, and m is from 2 to 10. The linking group Q₃ comprises di- or higher valent, alkylene, arylene, heteroalkylene, carbonyl, or sulfonyl functionality, or combinations thereof. The X group may comprise a (meth)acryl, —COCF═CH₂, —SH, allyl, or vinyl group.

Examples of useful fluorinated (meth)acryl monomers according to Formula II include:
HFPO—CONH—C(CH₂O₂CCH═CH₂)₃;
HFPO—CON(CH₂CH₂O₂CCH═CH₂)₂;
HFPO—CONH—CH₂CH₂N(COCH═CH₂)CH₂O₂CCH═CH₂;
HFPO—CONH—CH(CH₂O₂CCH═CH₂)₂;
HFPO—CONH—C(CH₃)(CH₂O₂CCH═CH₂)₂;
HFPO—CONH—C(CH₂O₂CCH═CH₂)₂CH₂CH₃;
HFPO—CONH—CH₂CH(O₂CCH═CH₂)CH₂O₂CCH═CH₂;
HFPO—CONH—CH₂CH₂CH₂N(CH₂CH₂O₂CCH═CH₂)₂;
HFPO—CO₂—CH₂C(CH₂O₂CCH═CH₂)₃;
HFPO—CONH—(CH₂CH₂N(C(O)CH═CH₂))₄CH₂CH₂NCO—HFPO;
CH₂═CHCO₂CH₂CH(O₂C—HFPO)CH₂OCH₂CH(OH)CH₂OCH₂CH(O₂C—HFPO)CH₂O₂CCH═CH₂;
HFPO—CH₂OCH₂CH(O₂CCH═CH₂)CH₂O₂CCH═CH₂
HFPO—CONH—CH₂CH₂O₂CCH═CH₂;
HFPO—CONH—CH₂CH₂OCH₂CH₂O₂CCH═CH₂;
HFPO—CONH—(CH₂)₆O₂CCH═CH₂;
HFPO—CONH—CH₂CH₂OCH₂CH₂OCH₂CH₂O₂CCH═CH₂.

In another embodiment, the fluorinated (meth)acryl monomer may comprise a monomer preparable by Michael-type addition of a reactive fluorinated polyether to a compound having a plurality of (meth)acryl groups. These monomers are described in US 2005/0250921 A1. A reactive fluorinated polyether is prepared by reacting a fluorinated polyether with a diamine in a 1:1 molar ratio. Useful fluorinated polyethers include HFPO—CO₂CH₃; CH₃O₂C(OCF₂CF₂)ₚ(OCF₂CF(CF₃))_{q}(OCF₂)ₜCO₂CH₃ having an average molecular weight of about 2000 g/mol and available as FOMBLIN Z-DEAL from Ausimont, USA; F(CF(CF₃)CF₂O)ₐCF(CF₃)COF having an average molecular weight of about 1115 g/mol and prepared as described in U.S. Pat. No. 3,250,808; F(CF(CF₃)CF₂O)ₐCF(CF₃)CONHCH₂CH₂O₂CCH═CH₂ prepared as described in US 2005/0250921 A1. Useful diamines include N-methyl-1,3-propanediamine; N-ethyl-1,2-ethanediamine; 2-(2-aminoethylamino)ethanol; pentaethylenehexaamine; ethylenediamine; N-methylethanolamine; and 1,3-propanediamine.

The Michael-type addition monomer is then prepared by reacting the reactive fluorinated polyether with the compound having a plurality of (meth)acryl groups in a 1:1 molar ratio. Useful compounds having a plurality of (meth)acryl groups include those having at least one acryl group, for example, trimethylolpropane triacrylate (TMPTA); pentaerythritol triacrylate (PET3A); dipentaerythritol pentaacrylate; ethoxylated(3) TMPTA; ethoxylated(4) pentaerythritol tetraacrylate; and 1,4-butanediol diacrylate, all of which are available from Sartomer Co. One particular monomer of this type comprises the reaction product of HFPO—CO₂CH₃ with H₂NCH₂CH₂CH₂NHCH₃ followed by reaction with TMPTA.

The fluorinated (meth)acryl monomer may also comprise any of those described in U.S. Pat. Nos. 3,810,874 and 4,321,404; for example, the monomer may comprise CH₂═CHC(O)OCH₂CF₂O(CF₂CF₂O)ₘₘ(CF₂O)ₙₙCH₂OC(O)CH═CH₂ wherein mm and nn are the number of randomly distributed perfluoroethyleneoxy and perfluoromethyleneoxy backbone repeating units, respectively, and mm and nn are independently from 1 to 50, such that the ratio of mm to nn is from 0.2:1 to 5:1. The fluorinated (meth)acryl monomer may also comprise a thiol, for example, HFPO—CONH—CH₂CH₂O₂CCH₂SH. The perfluoropolyether(meth)acryl monomer may also comprise a vinyl compound such as HFPO—CONH—CH₂CH═CH₂ or HFPO—CONH—CH₂CH₂OCH═CH₂.

In another embodiment, the fluorinated (meth)acryl monomer may comprise urethane functionality wherein the monomer comprises the reaction product of an isocyanate with a monomer comprising meth(acryl) functionality. These urethane monomers may be particularly useful because fluorinated materials can migrate to the surface of the article over time and are water repellent, and antistats can go to the surface and are water absorbing. Thus, these two components can be combined into a single formulation for coating which both simplifies and reduces manufacturing costs.

One example of this type of monomer is a fluorinated (meth)acryl urethane monomer comprising the reaction product of a multifunctional isocyanate with at least one equivalent of HXQR_{f2} and at least one equivalent of HOQAP and is represented by Formula III:

Rᵢ(NHCO—XQR_{f2})ₘ(NHCO—OQAₚ)ₙ (III)

wherein Rᵢ comprises a residue of a multifunctional isocyanate having k isocyanate groups; X comprises O, S or NR wherein R═H or an alkyl group having from 1 to 4 carbon atoms; Q comprises independently a di- or higher valent linking group; R_{f2} comprises a monovalent perfluoropolyether group; A comprises a (meth)acryl group; k=2 to 10; m is at least 1 and n is at least 1 with the proviso that m+n=k; and p=2 to 6.

Multifunctional isocyanates include those that are aliphatic and aromatic such as hexamethylene diisocyanate, toluene diisocyanate, and isophorone diisocyanate which are available as DESMODUR products from Bayer Polymers LLC. Q can be a straight, branched, or cyclic group comprising alkylene, arylene, araalkylene, alkarylene, carbonyl, or sulfonyl functionality, or combinations thereof R_{f2} may have the formula (F(R_{fc}O)ₓC_{d}F_{2d})— wherein R_{fc} comprises a fluorinated alkylene group having from 1 to 6 carbon atoms, d=1 to 6, and x is at least 2. R_{fc} can be —CF₂CF(CF₃). R_{f2} can be —HFPO. A comprises a (meth)acrylate group or COCF═CH₂. The fluorinated (meth)acryl urethane monomer typically comprises a mixture of monomers with respect to m and n. That is, for a given value of m and n, the monomer comprises a mixture of monomer in which some molecules have m=0, n=0, equal m and n values, etc.

Examples of HXQR_{f2} include HOCH₂CH₂NHCO—HFPO and (H₃C)HN(CH₂)₃NHCO—HFPO. Examples of HOQAₚ.include 1,3-glycerol dimethacrylate and pentaerythritol triacrylate. In one particular example, the fluorinated (meth)acryl urethane monomer may comprise:

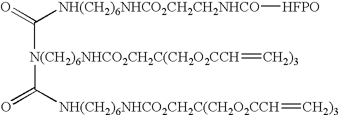

This monomer is prepared from hexamethylene diisocyanate, HOCH₂CH₂NHCO—HFPO, and pentaerythritol, according to the procedure described in U.S. Ser. No. 11/087413.

In another embodiment, the fluorinated (meth)acryl urethane monomer may be represented by Formula IV:

Rᵢ(NHCO—XQR_{f2})ₘ(NHCO—OQAₚ)ₙ(NHCO—XQG)ₒ(NCO)_{q} (IV)

wherein Rᵢ, k, X, Q, R_{f2}, A, and p are the same as described for Formula III; G comprises an alkyl, aryl, alkaryl, or araalkyl group, any of which may comprise O, N, S, carbonyl, sulfonyl, fluoroalkyl, perfluoroalkyl, pendant or terminal reactive groups such as (meth)acryl, vinyl, allyl, and trialkoxysilane groups, or combinations thereof, and m is at least 1, n is at least 1, o is at least 1, and q is 0 or greater, with the provisos that m+n+o+q=k and (m+n+o)/k is greater than or equal to 0.67 The fluorinated (meth)acryl urethane monomer of Formula IV comprises the reaction product of a multifunctional isocyanate with at least one equivalent of HXQR_{f2}, at least one equivalent of HOQAₚ, and at least one equivalent of HXQG. Examples of the latter include HOCH₂CH₂O₂CCH═CH₂, C₄F₉SO₂N(CH₃)CH₂CH₂OH, (CH₃O)₃SiCH₂CH₂CH₂NH₂, and (CH₃O)₃SiCH₂CH₂CH₂SH.

In another embodiment, the fluorinated (meth)acryl urethane monomer may be represented by Formula V:

(Rᵢ)_{c}(NHCO—XQR_{f2})ₘ(NHCO—OQAₚ)ₙ(NHCO—XQG)ₒ(R_{f2}Q(X—CONH)_{y})_{z}(NHCO—XQD(QX—CONH)u)ᵤ)ₛ(D₁(QX—CONH)_{y})_{zz}(NHCO₂QA₁Q₁QAₜO₂CNH)ᵥ(NCO)_{w} (V)

wherein Rᵢ, k, X, Q, R_{f2}, A, G, and p are the same as described for Formula IV; D comprises an alkylene, alkarylene, araalkylene, fluoroalkylene, or perfluoroalkylene group, any of which may comprise O, N or S; D₁ comprises an alkyl, aryl, alkaryl, araalkyl, fluoroalkyl, or perfluoroalkyl group, any of which may comprise O, N or S; Q₁ comprises a di- or higher valent linking group that may be a straight, branched, or cyclic group comprising alkylene, arylene, araalkylene, alkarylene, carbonyl, or sulfonyl functionality, or combinations thereof; c=1 to 50; m or z is at least 1, n or v is at least 1, y is independently 2 or greater, u is independently from 1 to 3, and each of o, s, v, w, z, and zz is independently 0 or greater, with the provisos that (m+n+o+[(u+1)s]+2v+w+yz+y(zz))=ck and (m+n+o+[(u+1)s]+2v+yz+y(zz))/ck=at least 0.75; and t=1 to 6.

The fluorinated (meth)acryl urethane monomer of Formula V comprises the reaction product of a multifunctional isocyanate with a combination of HXQR_{f2}, HOQAₚ, HXQG, R_{f}Q(XH)_{y}, HXQD(QXH)ᵤ, D₁(QXH)_{y}, and HOQAₜQ₁QAₜOH. Examples of R_{f}Q(XH)_{y} include HFPO—CONHCH₂CH₂CH₂N(CH₂CH₂OH)₂. Examples of HXQD(QXH)ᵤ include hydrocarbon and fluorocarbon diols such as OH(CH₂)₁₀OH and OHCH₂(CF₂)₄CH₂OH. Examples of D₁(QXH)_{y} include C₄F₉SO₂N(CH₂CH₂OH)₂. Examples of HOQAₜQ₁QAₜOH include hydantoin hexaacrylate and CH₂═C(CH₃)CO₂CH₂CH(OH)CH₂O(CH₂)₄OCH₂CH(OH)CH₂O₂CC(CH₃)═CH₂.

If the fluorinated (meth)acryl urethane monomer described above is used, care must be taken to avoid highly crosslinked urethane polymer gels. For example, if a trifunctional isocyanate is to be used with a multifunctional alcohol, the amount of the latter should be limited to avoid forming a crosslinked network. For high numbers of c, it may be desirable that primarily diols and diisocyanates be used.

In another embodiment, the fluorinated (meth)acryl urethane monomer may be represented by Formula VI:

(Rᵢ)_{c}(NHCO—XQR_{f2})ₘ(NHCO—OQAₚ)ₙ(NHCO—XQG)ₒ(NHCO—XQR_{f3}(QX—CONH)ᵤ)ᵣ(NHCO—XQD(QX—CONH)ᵤ)ₛ(D₁(QX—CONH)_{y})_{zz}(NHCO₂QAₜQ₁QAₜO₂CNH)ᵥ(NCO)_{w} (VI)

wherein Rᵢ, k, X, Q, R_{f2}, A, G, D, D₁, Q₁, c, p, and t are the same as described for Formula V; R_{f3} comprises Y((R_{fc2}O)ₓC_{d2}F_{2d2})_{b} wherein R_{fc2} independently comprises a fluorinated alkylene group having 1 to 6 carbon atoms, x is independently an integer of at least 2, d2 is an integer from 0 to 6, and Y comprises a polyvalent organic group having a valence of b wherein b is an integer of at least 2; n or v is at least 1, r is at least 1, y is independently 2 or greater, u is independently from 1 to 3, and each of m, o, s, v, w, and zz is independently 0 or greater, with the provisos that (m+n+o+[(u+1)r]+[(u+1)s]+2v+w+y(zz))=ck and (m+n+o+[(u+1)r]+[(u+1)s]+2v+y(zz))/ck=at least 0.75. The fluorinated (meth)acryl urethane monomer of Formula VI comprises the reaction product of a multifunctional isocyanate with a combination of HXQR_{f2}, HOQAₚ, HXQG, HXQR_{f3}(QXH)ᵤ, HXQD(QXH)ᵤ, D₁(QXH)_{y}, and HOQAₜQ₁QAₜOH. Examples of HXQR_{f3}(QXH)ᵤ include H(OCH₂C(CH₃)(CH₂OCH₂CF₃)CH₂)ₐₐOH having a molecular weight of about 1342 and available from Omnova Solutions Inc.

In yet another embodiment, the fluorinated (meth)acryl urethane monomer may be represented by Formula VII:

R_{f2}Q(XCONHQCO₂CR═CH₂)_{f} (VII)

wherein R_{f2}, X, and Q are the same as described for Formula VII, and f=1 to 5. Particular examples of fluorinated (meth)acryl urethane monomers having Formula III are:

HFPO—CONHC₂H₄OCONHC₂H₄CO₂C(CH₃)═CH₂HFPO—CON(C₂H₅)(C₂H₄OCONHC₂H₄CO₂C(CH₃)═CH₂)₂

The fluorinated (meth)acryl monomer is selected to impart low surface energy to the surface of the hardcoat layer. The particular choice of monomer used in the fluorochemical surface layer depends on a variety of factors such as the desired surface energy, compatibility with other components in the flurochemical surface layer either before or after it is coated and/or cured, the desired thickness of the layer, the desired concentration of the monomer necessary for coating, polymerization conditions, cost, etc.

The fluorinated (meth)acryl monomer may comprise one monomer represented by any one of the Formulas I through VII. Alternatively, a mixture of monomers may be used, such as two different monomers represented by any one of the Formulas I through VII, or one monomer represented by Formula I and another by Formula III, etc. A useful combination of fluorinated (meth)acryl monomers includes a fluorinated (meth)acryl urethane monomer having multiple (meth)acryl groups at terminal positions and a fluorinated (meth)acryl monomer represented by Formulas I or II. In this case, if a surface having a low surface energy is desired, it may be useful for the fluorinated (meth)acryl monomer represented by Formulas I or II to have a higher wt.% of fluorine as compared to the fluorinated (meth)acryl urethane monomer. Also, if a surface having a low surface energy is desired, it may be useful to maximize the amount of fluorinated (meth)acryl monomer represented by Formulas I or II as long as compatibility of the monomer in the composition used to form the layer is not compromised. In this case, the fluorinated (meth)acryl urethane monomer can be used in a relatively small amount to maintain or improve compatibility.

The fluorochemical surface layer may further comprise a fluorinated (meth)acryl monomer having a fluoroalkyl or fluoroalkylene group up to 8 carbon atoms in order to improve compatibility of the fluorinated (meth)acryl monomer in the layer and/or in the composition used to form the layer. Examples include C₄F₉SO₂N(CH₃)(CH₂CH₂O₂CH═CH₂); C₄F₉SO₂N(CH₂CH₂O₂CH═CH₂)₂; C₄F₉SO₂N(CH₂CH₂O₂C(CH₃)═CH₂)₂; 2,2,3,3,4,4,5,5-octafluorohexanediol diacrylate; and 2,2,3,3,4,4,5,5-octafluoropentyl acrylate; C₄F₉SO₂N(CH₃)(CH₂CH₂SH); C₄F₉SO₂N(CH₃)(CH₂CH₂O₂CCH₂SH); C₄F₉SO₂N(CH₃)(CH₂CH₂O₂CCH₂CH₂SH); and C₄F₉SO₂N(CH₃)CH(O₂CCH₂SH)(CH₂O₂CCH₂SH).

The amount of fluorinated (meth)acryl monomer used in the fluorochemical surface layer may depend upon the particular monomer being used, the desired properties of the fluorochemical surface layer, and a variety of other factors including compatibility with the other components in the composition used to form the fluorochemical surface layer, as well as the fluorochemical surface layer after it is formed. Accordingly, the fluorinated (meth)acryl monomer used in the fluorochemical surface layer may comprise from about 5 to about 40 wt. % of the fluorochemical surface layer. In some cases, it may be desirable for the total wt.% of fluorine in the fluorochemical surface layer to comprise from about 10 to about 20 wt. % of the fluorochemical surface layer. If the fluorinated (meth)acryl monomer comprises a mixture of a non-urethane-containing monomer and a urethane containing monomer, then the weight ratio of non-urethane to urethane may be from about 0.2 to about 2, respectively. If a monomer having a fluoroalkyl or fluoroalkylene group up to 8 carbon atoms is used, useful amounts include anywhere from half to twice the amount of fluorinated (meth)acryl monomer present in the composition used to form the fluorochemical surface layer.

The composition used to form the fluorochemical surface layer further comprises a non-fluorinated crosslinking agent such as a multifunctional (meth)acrylate monomer, i.e., a monomer or oligomer comprising at least two (meth)acryl groups. The multifunctional (meth)acrylate monomer may be selected from the group consisting of di(meth)acryl monomers of alkanediols, di(meth)acryl monomers of glycols, di(meth)acryl monomers of bisphenol A, tri(meth)acryl monomers of alkanetriols, and tri(meth)acryl monomers of alkoxylated alkanetriols. Useful multifunctional (meth)acrylate monomers include one or more (meth)acryl monomers selected from the group consisting of (a) di(meth)acryl monomers such as 1,3-butylene glycol diacrylate, 1,4-butanediol diacrylate, 1,6-hexanediol diacrylate, 1,6-hexanediol monoacrylate monomethacrylate, ethylene glycol diacrylate, alkoxylated aliphatic diacrylates, alkoxylated cyclohexane dimethanol diacrylate, alkoxylated hexanediol diacrylate, alkoxylated neopentyl glycol diacrylate, caprolactone modified neopentylglycol hydroxypivalate diacrylate, diethylene glycol diacrylate, dipropylene glycol diacrylate, ethoxylated bisphenol A diacrylate, hydroxypivalaldehyde modified trimethylolpropane diacrylate, neopentyl glycol diacrylate, polyethylene glycol diacrylate, propoxylated neopentyl glycol diacrylate, tetraethylene glycol diacrylate, tricyclodecanedimethanol diacrylate, triethylene glycol diacrylate, tripropylene glycol diacrylate; (b) tri(meth)acryl monomers such as glycerol triacrylate, trimethylolpropane triacrylate, ethoxylated trimethylolpropane triacrylates, propoxylated glyceryl triacrylates, propoxylated trimethylolpropane triacrylates, tris(2-hydroxyethyl)isocyanurate triacrylate; (c) higher functionality (meth)acryl monomers such as ditrimethylolpropane tetraacrylate, dipentaerythritol pentaacrylate, ethoxylated pentaerythritol tetraacrylate, caprolactone modified dipentaerythritol hexaacrylate; and (d) oligomeric (meth)acryl monomers such as urethane acrylates, polyester acrylates, and epoxy acrylates. Acrylamide analogues of the any of the foregoing may also be used. Additional useful multifunctional (meth)acrylate monomers include hydantoin-containing poly(meth)acrylates, for example, as described in U.S. Pat. No. 4,262,072. In particular, the multifunctional (meth)acrylate monomer may be selected from the group consisting of trimethylolpropane triacrylate, pentaerythritol triacrylate, pentaerythritol tetraacrylate, dipentaerythritol pentaacrylate, or combinations thereof. Multifunctional (meth)acrylate monomers are widely available from vendors such as Sartomer Company, UCB Chemicals Corporation, and Aldrich Chemical Company.

The multifunctional (meth)acrylate monomer is selected to impart integrity and any other desired properties to the fluorochemical surface layer, and without affecting the antistatic properties and the low surface energy provided by the other components. The particular multifunctional (meth)acryl monomer used is preferably non-fluorinated. The particular choice of multifunctional (meth)acrylate monomer and the amount used depends on a variety of factors such as compatibility with other components in the layer either before or after it is coated and/or cured, the desired thickness of the layer, polymerization conditions, cost, etc. Accordingly, the multifunctional (meth)acrylate may comprise from about 50 to about 80 wt. % of the fluorochemical surface layer.

The fluorochemical surface layer generally has a thickness of from about 10 to about 200 nm. The fluorochemical surface layer should be thick enough to impart desirable properties but not so thick that it would crack or detract from optical performance. Ideally, the fluorochemical surface layer has a refractive index close to that of the hardcoat layer and the light transmissive substrate so that optical defects, visible to the eye, are minimized.

The hardcoat layer is a tough, abrasion resistant layer that protects the light transmissive substrate and the underlying display panel from damage due to physical abrasion, fingerprints, etc. from causes such as scratches, abrasion and solvents. Typically the hardcoat is formed by coating a curable liquid ceramer composition onto the substrate and then curing the composition to form a hardened film. Further details for hardcoats can be found in the following references which are incorporated herein by reference for all that they contain: U.S. Pat. No. 5,677,050; U.S. Pat. No. 6,132,861; U.S. Pat. No. 6,238,798 B1; U.S. Pat. No. 6,245,833 B1; U.S. Pat. No. 6,299,799 B1; U.S. Pat. No. 7,101,618 B2; U.S. Pat. No. 7,173,778 B2; US 2006/0216524 A1; and US 2006/0216500A1.

The hardcoat layer comprises a (meth)acrylate-functionalized metal oxide having an average particle size of less than about 100 nm. Useful metal oxide particles are substantially spherical in shape and may be monodisperse or polydisperse. The metal oxide particles are colloidal particles having an average particle size of less than about 100 nm in order to minimize scattering and maintain optical clarity. The particles may also have an average particle size of less than about 50 nm, or less than about 30 nm. The metal oxide particles may comprise silica, alumina, titania, zirconia, tin oxide, mixed oxides thereof, or combinations thereof. For example, the metal oxide particles may comprise silica or a combination of silica and alumina. The metal oxide particles may also comprise core/shell particles wherein the core may be inorganic or organic, and the shell is the metal oxide. The metal oxide particles may be provided in the form of a colloidal dispersion in water or a mixture of water and an organic solvent. The colloidal dispersions are sometimes referred to as sols. Examples of commercially available colloidal dispersions of metal oxides include LUDOX from E.I. duPont de Nemours, NYACOL from Nyacol Co., NALCO from Nalco Chemical Co. The metal oxide particles are functionalized with (meth)acrylate groups as described in U.S. Pat. No. 5,677,050 and references cited therein. Typically, functionalization is carried out by adding a silyl(meth)acrylate to a colloidal dispersion of the metal oxide particles. One class of useful silyl(meth)acrylate are referred to as trialkoxysilanes. In a particular example, the metal oxide comprises silica functionalized with 3-methacryloyloxypropyl trimethoxysilane (3-MPTMS). The amount of (meth)acrylate-functionalized metal oxide particles used is from about 15 to about 50 wt. % of the hardcoat layer.

The hardcoat composition further comprises a multifunctional (meth)acrylate monomer, and useful ones include any of those described above for the fluorochemical surface layer. The multifunctional (meth)acrylate monomer used in the hardcoat layer is selected to impart integrity and any other desired properties to the hardcoat layer, and without affecting the antistatic properties and the low surface energy provided by the other components. The particular choice of multifunctional (meth)acrylate monomer and the amount used depends on a variety of factors such as compatibility with other components in the layer either before or after it is coated and/or cured, the desired thickness of the layer, polymerization conditions, cost, etc. Accordingly, the multifunctional (meth)acrylate may comprise from about 15 to about 60 wt. % of the hardcoat layer.

The hardcoat composition may further comprise one or more low molecular weight amide monomers which are generally used to stabilize the sols described above, and/or to improve coating quality, optical performance, adhesion, etc. N,N-disubstituted acrylamide monomers and/or N-substituted-N-vinyl-amide monomers may be used as described in U.S. Pat. No. 5,677,050. The amide monomer may comprise C₁ to C₈ alkyl groups, C₂ to C₈ alkylene groups, and may be straight, branched, cyclic, aryl, or a combination thereof The N-substituents may also be covalently linked such as in N-vinylpyrrolidone. The N-substituents may also be substituted with heteroatoms such as halides, oxygen, nitrogen, etc. Preferred amide monomers include N,N-dimethylacrylamide. N-vinyl pyrrolidone may also be used. Accordingly, the low molecular weight amide monomers may comprise from about 1 to about 10 wt. % of the hardcoat layer.

The hardcoat layer may comprise a fluorinated (meth)acryl monomer in order to impart low surface energy to the surface of the optical article as described above. Fluorinated (meth)acryl monomers useful in the hardcoat layer include any of those described above for use in the fluorochemical surface layer. The amount of fluorinated (meth)acryl monomer used in the hardcoat layer depends on the particular monomer as well as on a variety of factors for the hardcoat layer as described above. Accordingly, if used, the fluorinated (meth)acryl monomer may comprise from about 0.3 to about 20 wt. % of the hardcoat layer.

The relative amounts of the materials used in the hardcoat layer will depend upon the particular materials being used, as well as the thickness of the layer, and the intended use of the optical article. The hardcoat layer generally has a thickness of less than about 100 um, for example, between 2 and 100 um, or between 2 and 25 um. The hardcoat layer should be thick enough to impart desirable properties but not so thick that it would crack or detract from optical performance. Ideally, the hardcoat layer has a refractive index close to that of the light transmissive substrate so that optical defects, visible to the eye, are minimized. The refractive index of the fluorochemical surface layer is lower than that of the hardcoat layer.

The hardcoat and fluorochemical surface layers may further comprise at least one free-radical thermal and/or photoinitiator in order to facilitate curing. Useful free-radical thermal initiators include azo, peroxide, persulfate, and redox initiators, and combinations thereof. Useful free-radical photoinitiators include those used for UV curing of (meth)acrylate polymers. Examples of useful photoinitiators include benzophenone, benzoin, acetophenone, ketone, anthraquinone, onium salt, titanium complexes, nitrobenzene, acylphosphine photoinitiators, such as those available as IRGACURE, DAROCUR, and CGI products available from Ciba Specialty Chemicals. In general, the amount of thermal and/or photoiniator used is less than about 5 wt. % of the total coating solids. Sensitizers may also be used.

The hardcoat and fluorochemical surface layers are each formed by coating a composition comprising the desired components dissolved or suspended in a suitable solvent directly onto the light transmissive substrate. The particular solvent used depends upon the particular components, the desired concentrations of the components, the desired thickness and nature of the hardcoat layer, the coating method employed, etc. Suitable solvents include methyl ethyl ketone, methyl isobutyl ketone, methyl propyl ketone, and ethyl acetate. Generally, compositions used to form the hardcoat layer comprise up to about 50 wt. % solids relative to the weight of the total composition. Compositions used to form the fluorochemical surface layer comprise up to about 10 wt. % solids relative to the weight of the total composition.

The compositions used to form the layers may be coated using a variety of coating techniques such as dip coating, forward and reverse roll coating, wire wound rod coating, and die coating. Die coating techniques include knife, slot, slide, and curtain coating. A comprehensive discussion of coating techniques can be found in Cohen, E. and Gutoff, E. Modem Coating and Drying Technology; VCH Publishers: New York, 1992; p. 122; and in Tricot, Y-M. Surfactants: Static and Dynamic Surface Tension. In Liquid Film Coating; Kistler, S. F. and Schweizer, P. M., Eds.; Chapman & Hall: London, 1997; p. 99.

The compositions used to form the layers are cured using free-radical curing techniques known in the art including thermal curing methods as well as radiation curing methods such as electron beam or UV radiation. UV radiation comprising C dosage of about 5 to 60 mJ/cm² may be used. Further details concerning free radical thermal and photopolymerization techniques may be found in, for example, U.S. Pat. Nos. 4,654,233; 4,855,184; and 6,224,949.

The optical article disclosed herein comprises a light transmissive substrate suitable for use in a display device. Generally, this means that light can be transmitted through the substrate such that the display panel can be viewed. In general, for optimum performance of the display device, the light transmissive substrate has a transmission of greater than about 90%, and a haze value of less than 5%, for example, less than 2%, or less than 1%. Other properties to consider include mechanical properties such as flexibility, dimensional stability, self-supportablity, and impact resistance. The choice of the particular light transmissive substrate will depend on the particular display device in which it will be used.

The light transmissive substrate may comprise any of a variety of materials such as polyesters, polycarbonates, poly(meth)acryls, polyolefins, polyurethanes, polyamides, polyimides, phenolic resins, cellulose acetates, polystyrene, and the like. Particular examples include polyethylene terephthalate, polymethyl methacrylate, polyvinyl chloride, and cellulose triacetate. The substrate may be an oriented film. The thickness of the light transmissive substrate is typically less than about 0.5 mm.

The substrate may be a reflective substrate, for example, one used in graphic arts applications. The substrate may also comprise a multilayer optical film such as those described in U.S. Pat. No. 6,991,695 and US 2006/0216524 A1. The multilayer optical films may be composed of some combination of all birefringent optical layers, some birefringent optical layers, or all isotropic optical layers. They can have ten or less layers, hundreds, or even thousands of layers. Multilayer optical films are used in a wide variety of applications. For example, reflective polarizers and mirrors can be used in LCD devices to enhance brightness, and/or reduce glare at the display panel. The optical film may also be a polarizer which can be used in sunglasses to reduce light intensity and glare. The optical film may comprise a polarizer film, a reflective polarizer film, a diffuse blend reflective polarizer film, a diffuser film, a brightness enhancing film, a turning film, a mirror film, or a combination thereof.

Useful optical films include commercially available optical films marketed as Vikuiti™ Dual Brightness Enhanced Film (DBEF), Vikuiti™ Brightness Enhanced Film (BEF), Vikuiti™ Diffuse Reflective Polarizer Film (DRPF), Vikuiti™ Enhanced Specular Reflector (ESR), Vikuiti™ Advanced Polaring Film (APF), all available from 3M Company. Useful optical films are also described in U.S. Pat. Nos. 5,825,543; 5,867,316; 5,882,774; 6,352,761 B1; 6,368,699 B1; 6,927,900 B2; 6,827,886; U.S. 2006/0084780 A1; WO 95/17303; WO 95/17691; WO95/17692; WO 95/17699; WO 96/19347; WO 97/01440; WO 99/36248; and WO99/36262; all incorporated herein by reference. These optical films are merely illustrative and are not meant to be an exhaustive list of suitable optical films that can be used.

The optical film may have one or more non-optical layers, i.e., layers that do not significantly participate in the determination of the optical properties of the optical film. The non-optical layers may be used to impart or improve mechanical, chemical, optical, etc. any number of additional properties as described in any of the above references; tear or puncture resistance, weatherability, solvent resistance. For example, the light transmissive substrate may be treated or primed in order to increase interlayer adhesion between the substrate and the hardcoat layer. An adhesive for this purpose may also be used.

An optical adhesive layer may be provided on the light transmissive substrate, on the side opposite the hardcoat layer so that the optical article can be easily mounted to an exposed viewing surface of a display device or panel. The optical adhesive layer may comprise a permanent or removable grade adhesive or a thermoplastic rubber. The optical adhesive layer may comprise hydrogenated block copolymers such as KRATON copolymers available from Kraton Polymers, for example, KRATON G-1657. Other exemplary adhesives include acrylic-based, urethane-based, silicone-based, and epoxy-based adhesives. Preferred adhesives are of sufficient optical quality and light stability such that the adhesive does not yellow with time or upon weather exposure so as to degrade the viewing quality of the optical display. The adhesive can be applied using a variety of known coating techniques such as transfer coating, knife coating, spin coating, die coating and the like. Exemplary adhesives are described in U.S. 2003/0012936 A1. Several of such adhesives are commercially available from 3M Company under the trade designations 8141, 8142, and 8161.

The optical article may be used with a display device as described above. Accordingly, the components used to form the optical article must be selected so that the article has both the requisite antistatic and protective properties as described above. In addition, the components must be selected so that the optical article has desired optical properties depending on the particular application with which the article is used. For example, the optical article desirably shows little or no defects to the human eye, has a haze of less than about 5%, preferable less than about 2%, and has a transmission of at least about 90%.

### EXAMPLES

### Preparation of Optical Articles

### Examples 1-3

The hardcoat composition was formed as follows. Referring to U.S. Pat. No. 5,677,050, a solution comprising an acrylated colloidal silica was prepared as described for CER1, and this solution was then used to prepare Ceramer Hardcoat Composition (CHC) according to Example 1. The Ceramer Hardcoat Composition comprised: PETA at 25.4 wt. %, acrylated colloidal silica (NALCO 2327 from Nalco, functionalized with 3-MPTMS) at 18.5 wt. %, NNDMA at 4.0 wt. %, Irgacure® 184 at 6 wt. %, Tinuvin® 292 at 1 wt. %, butylated hydroxytoluene at 0.02 wt. %, phenothiazine at 0.0025 wt. %, for a total of 30 wt % solids in 1:1 (w/w) IPA:toluene. The web speed was 30 ft/min, UV power was 100% (300 watt H bulb), and solution flow rate was 18.8 ml/min yielding a 0.798 mil wet film thickness and 4.12 μ dry film thickness.

The fluorochemical surface layer was formed over the hardcoat layer as follows. A perfluoropolyether(meth)acryl urethane monomer (FUA-1) was prepared as described for Example 6 in US 2006/0216524A1; FUA-1 comprised: Desmodur® N100, HFPO—C(O)NH—CH₂CH₂OH, and PET3A in a mole ratio of 100:15:85. A fluorochemical surface layer solution was then prepared by combining the following resins: TMPTA, HFPO—C(O)NH—CH₂CH₂O₂CH═CH₂ , FUA-1 in a ratio of 87:3:10, all dissolved in MEK. An antistatic fluorochemical solution was prepared by mixing the fluorochemical surface layer solution with antimony zinc oxide (Celnax CXZ2101IP-F2 from Nissan Chemical, dispersed in IPA), IRGACURE 819, and additional MEK. The final solids ratio of the antistatic fluorochemical solution was 61:35:4 of (TMPTA, HFPO-C(O)NH-CH₂CH₂O₂CH=CH₂, and FUA-1): (Celnax CXZ210IP-F2:IRAGACURE 819. Of the final solids ratio of the antistatic fluorochemical solution composition, 4% was the solids (all three resins, nanoparticles, and photoinitiator) and 96% was solvent. The 96% solvent was 95.5:4.5 MEK:IPA. The antistatic fluorochemical solution was coated as follows: The web speed was 10 ft/min and UV power was 100% (D bulb). The solution flow rates were varied: 5.36 ml/min yielding a 220 nm dry film thickness (Example 1); 7 mL/min for 287 nm (Example 2); and 8.5 mL/min for 349 nm (Example 3).

### Control Optical Article

The Control was prepared the same except that the antimony zinc oxide was not included.

### Evaluation of Optical Articles

The optical articles were evaluated by measuring static charge decay time and contact angles as follows.

Charge decay time was measured on coated film samples using an Electro-Tech Systems, Inc. Model 406C static decay meter by charging the sample to 5 kV and measuring the time required for the static charge to decay to 10% of its initial value. Film samples approximately five inches on a side were cut and mounted between the meter electrodes using magnets. Reported values are an average of the decay times measured at both polarities. Measurements were made under a variety of conditions, such as before and after rinsing under a hot tap water stream for 10 sec, drying at 110° C./3 min, exposure to 70 F/50% RH overnight in a CTH room, and exposure to low ambient laboratory humidity (˜30% RH) overnight. The results are shown in Table 1.

TABLE 1

| | Charge Decay Time (sec) | | | |
|---|---|---|---|---|
| | Before | After Rinse + Dry/ | 50% RH | ~30% RH |
| Example | Rinse | 110 C. | (no rinse) | (no rinse) |
| 1 | 1.0 | 2.2 | 0.7 | 0.6 |
| 2 | 0.4 | 0.9 | 0.5 | 0.5 |
| 3 | 0.6 | 0.6 | 0.2 | 0.2 |
| Control | WNC | WNC | WNC | WNC |

WNC = would not charge

Contact angle measurements were made using as-received reagent-grade hexadecane (Aldrich) and deionized water filtered through a filtration system obtained from Millipore Corporation (Billerica, Mass.), on a video contact angle analyzer VCA-2500XE from AST Products (Billerica, Mass.). Reported values are the averages of measurements on at least three drops measured on the right and the left sides of the drops. Drop volumes were 5 μL for static measurements and 1-3 μL for advancing and receding. For hexadecane, only advancing and receding contact angles are reported because static and advancing values were found to be nearly equal. The results are shown in Table 2.

TABLE 2

| | Water Static/Adv/Rec | Hexadecane Adv/Rec |
|---|---|---|
| Example | CA (deg) | CA (deg) |
| 1 | 114/122/97 | 72/62 |
| 2 | 115/124/98 | 74/63 |
| 3 | 115/124/96 | 71/67 |
| Control | 99/109/74 | 58/48 |

### Example 4

The substrate used in this experiment was a cellulose triacetate (TAC) film coated in the same manner with the ceramer hardcoat of Examples 1-3. A fluorochemical surface layer was applied to this substrate by coating, with a #4 wire-wound rod (obtained from RD Specialties, Webster, N.Y.), a solution prepared by combining 1.0 g of the concentrate from Examples 1-3 (10% wt solids), 8.2 g of isopropyl alcohol, 0.4 g a solution of 1% wt Irgacure® 127 in MEK, and 1.0 g of 30 wt % antimony tin oxide nanoparticle dispersion in IPA (30 nm particle size, obtained from Advanced Nano Products Co., Ltd. (Chungcheongbuk-do, Korea)). The film was allowed to dry at room temperature, then cured using two passes through a Fusion Lighthammer UV system equipped with an H-bulb, operating under nitrogen atmosphere and a line speed of 12 feet/min). The resulting coated film was evaluated by static charge decay and contact angle analysis using the methods described in Examples 1-3, and haze (%H) and transmission (%T) were measured using a Haze-Gard Plus (BYK-Gardner USA, Columbia, Md.). Static charge decay times were measured on fresh coating at ambient (30-40% RH) humidity. Results are shown in Table 3.

### Example 5

A fluorochemical surface layer was applied to the substrate from Example 4 by coating, with a #4 wire-wound rod, a solution prepared by combining 1.0 g of the concentrate from Examples 1-3 (10% wt solids), 8.2 g of isopropyl alcohol, 0.4 g a solution of 1% wt Irgacure® 127 in MEK, and 1.0 g 30 wt % indium tin oxide nanoparticle dispersion in 1-methoxy-2-propanol (obtained from Advanced Nano Products). The film was allowed to dry at room temperature, then cured using the UV cure method described in Example 4. The resulting coated film was evaluated using the methods described in Example 4. Results are shown in Table 3.

### Example 6

2 g of the coating solution from Example 4, and 5 g of the coating solution from Example 5 were mixed together, and then coated on a piece of the substrate used in Examples 4 and 5 and cured and evaluated using the same methods described in those Examples. Results are shown in Table 3.

### Example 7

A fluorochemical layer was applied to the substrate from Example 4 by coating, with a #4 wire-wound rod, a solution prepared by combining 1.0 g of the concentrate from Examples 1-3 (10% wt solids), 8.2 g of isopropyl alcohol, 0.4 g a solution of 1% wt Irgacure® 127 in MEK, 0.25 g 30% antimony tin oxide nanoparticle dispersion in 1-methoxy-2-propanol (Advanced Nano Products), and 0.75 g of 30 wt % indium tin oxide nanoparticle dispersion in 1-methoxy-2-propanol (Advanced Nano Products). The film was allowed to dry at room temperature, then cured using the UV cure method described in Example 4. The resulting coated film was evaluated using the methods described in Example 4. Results are shown in Table 3.

TABLE 3

| | | | | | Contact | | |
|---|---|---|---|---|---|---|---|
| | | | | | Angle (deg) | | |
| Example | % T | % H | CD (sec) | Liquid | Static | Adv | Rec |
| 4 | 90.1 | 0.43 | 0.3-0.5 | Water | 107 | 111 | 49 |
| | | | | HD¹ | — | 61 | 24 |
| 5 | 90.3 | 0.60 | 1.1-10.0 | Water | 107 | 112 | 69 |
| | | | | HD | — | 61 | 41 |
| 6 | 90.2 | 0.45 | 0.8-2.0 | Water | 109 | 117 | 69 |
| | | | | HD | — | 64 | 45 |
| 7 | 90.6 | 0.48 | 0.03-0.05 | Water | 116 | 118 | 61 |
| | | | | HD | — | 64 | 36 |
| Control² | 92.7 | 0.31 | WNC³ | Water | 57 | 75 | 54 |
| | | | | HD | — | <20 | ~0 |

¹hexadecane
²hardcoat layer only, no fluorochemical surface layer
³would not charge

### Example 8

The abrasion resistance of the cured coatings from Examples 4-7 was tested cross-web to the coating direction by use of a mechanical device capable of oscillating a steel wool pad fastened to a stylus (by means of a pressure-sensitive adhesive) across the film's surface. The stylus oscillated over a 10 cm wide sweep width at a rate of 3.5 wipes/second wherein a “wipe” is defined as a single travel of 10 cm. The stylus had a flat, cylindrical geometry with a diameter of 1.25 inch (3.2 cm). The device was equipped with a platform on which weights were placed to increase the force exerted by the stylus normal to the film's surface. The steel wool was obtained from Rhodes-American, a division of Homax Products, Bellingham, Wash. under the trade designation “#0000-Super-Fine” and was used as received. Samples were tested by abrasion for 25 wipes under a 1 kg weight, and evaluated for scratching by visual evaluation. Black ink from a permanent Sharpie™ marker was applied to abraded and unabraded areas, and the behavior of the ink with respect to wetting or dewetting (beading) was noted. Results are reported in Table 4.

TABLE 4

Ink Beading
Performance

| | Results from Steel | | After Steel Wool |
|---|---|---|---|
| Example | Wool Testing | Initial | Testing |
| 4 | Slight scratch | Wetting | Wetting |
| 5 | Slight scratch | Partial | Partial |
| 6 | Slight scratch | Partial | Partial |
| 7 | Slight scratch | Partial | Partial |
| Control¹ | Heavy scratch | Wetting | Wetting |

¹cellulose triacetate film, no coating

Various modifications and alterations of this invention will be apparent to those skilled in the art without departing from the scope and spirit of the invention, and it should be understood that this invention is not limited to the examples and embodiments described herein.

What is claimed is:

1. An optical article comprising:
(a) a light transmissive substrate;
(b) a hardcoat layer disposed on the light transmissive substrate, the hardcoat layer comprising:
a (meth)acrylate-functionalized metal oxide having an average particle size of less than about 100 nm, and
a multifunctional (meth)acrylate monomer; and
(c) a fluorochemical surface layer disposed on the hardcoat layer opposite the light transmissive substrate, the fluorochemical surface layer comprising:
a fluorinated (meth)acryl monomer,
a non-fluorinated crosslinking agent, and
from about 25 to about 60 wt. % of conducting metal oxide nanoparticles;
wherein the fluorochemical surface layer exhibits little or no color change with respect to the fluorochemical surface layer without the nanoparticles.

2. The optical article of claim 1, the conducting metal oxide nanoparticles comprising antimony zinc oxide, antimony tin oxide, indium tin oxide, or combinations thereof.

3. The optical article of claim 1, the fluorinated (meth)acryl monomer represented by Formula I:
R_{f}—(W—R_{A})_{w} (I)
wherein R_{f} comprises a perfluoropolyether group, W comprises a linking group, and R_{A} comprises a (meth)acryl group or —COCF═CH₂, and w is 1 or 2.

4. The optical article of claim 1, the fluorinated (meth)acryl monomer comprising F(CF(CF₃)CF₂O)ₐCF(CF₃)—.

5. The optical article of claim 1, the fluorinated (meth)acryl monomer represented by Formula II:
(HFPO)ₙQ₃Xₘ (II)
wherein HFPO comprises F(CF(CF₃)CF₂O)ₐCF(CF₃)—, wherein a averages from 4 to 15; n is from 1 to 3; Q₃ comprises a linking group; X comprises a free-radically reactive group, and m is from 2 to 10.

6. The optical article of claim 1, the fluorinated (meth)acryl monomer represented by Formula III:
Rᵢ(NHCO—XQR_{f2})ₘ(NHCO—OQAₚ)ₙ (III)
wherein Rᵢ comprises a residue of a multifunctional isocyanate having k isocyanate groups; X comprises O, S or NR wherein R═H or an alkyl group having from 1 to 4 carbon atoms; Q comprises independently a di- or higher valent linking group; R_{f2} comprises a monovalent perfluoropolyether group; A comprises a (meth)acryl group; k=2 to 10; m is at least 1 and n is at least 1 with the proviso that m+n=k; and p=2 to 6.

7. The optical article of claim 1, the fluorinated (meth)acryl monomer comprising:

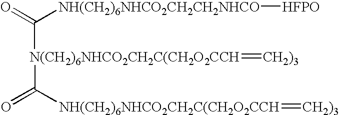

8. The optical article of claim 6, the fluorinated (meth)acryl monomer further comprising a monomer represented by Formula III:
Rᵢ(NHCO—XQR_{f2})ₘ(NHCO—OQAₚ)ₙ (III)
wherein Rᵢ comprises a residue of a multifunctional isocyanate having k isocyanate groups; X comprises O, S or NR wherein R═H or an alkyl group having from 1 to 4 carbon atoms; Q comprises independently a di- or higher valent linking group; R_{f2} comprises a monovalent perfluoropolyether group; A comprises a (meth)acryl group; k=2 to 10; m is at least 1 and n is at least 1 with the proviso that m+n=k; and p=2 to 6.

9. The optical article of claim 1, the non-fluorinated crosslinking agent selected from the group consisting of di(meth)acryl monomers of alkanediols, di(meth)acryl monomers of glycols, di(meth)acryl monomers of bisphenol A, tri(meth)acryl monomers of alkanetriols, and tri(meth)acryl monomers of alkoxylated alkanetriols.

10. The optical article of claim 1, the non-fluorinated crosslinking agent selected from the group consisting of trimethylolpropane triacrylate, pentaerythritol triacrylate, pentaerythritol tetraacrylate, dipentaerythritol pentaacrylate, or combinations thereof.

11. The optical article of claim 1, the fluorochemical surface layer comprising from about 5 to about 40 wt. % of the fluorinated (meth)acryl monomer and from about 50 to about 80 wt. % of the non-fluorinated crosslinking agent.

12. The optical article of claim 1, the fluorochemical surface layer having a thickness of from about 10 to about 200 nm.

13. The optical article of claim 1, having a surface resistivity greater than about 1×10⁸ ohms/sq.

14. The optical article of claim 1, having a charge decay time of less than about 2 seconds.

15. The optical article of claim 1, the hardcoat layer having a thickness of from about 3 to about 100 um.

16. The optical article of claim 1, the hardcoat layer and the light transmissive substrate having an adhesion of at least 3 according to ASTM D 3359.

17. The optical article of claim 1, the light transmissive substrate comprising a reflective film, a polarizer film, a reflective polarizer film, a diffuse blend reflective polarizer film, a diffuser film, a brightness enhancing film, a turning film, a mirror film, or a combination thereof.

18. The optical article of claim 1, further comprising an adhesive layer disposed on the light transmissive substrate on the side opposite the hardcoat layer.

19. A display device comprising:
a light source;
a display panel; and
an optical article disposed on the display panel on the side opposite the light source, the optical article comprising:
(a) a light transmissive substrate;
(b) a hardcoat layer disposed on the light transmissive substrate, the hardcoat layer comprising:
a (meth)acrylate-functionalized metal oxide having an average particle size of less than about 100 nm, and
a multifunctional (meth)acrylate monomer; and
(c) a fluorochemical surface layer disposed on the hardcoat layer opposite the light transmissive substrate, the fluorochemical surface layer comprising:
a fluorinated (meth)acryl monomer,
a non-fluorinated crosslinking agent, and
from about 25 to about 60 wt. % of conducting metal oxide nanoparticles,
wherein the fluorochemical surface layer exhibits little or no color change with respect to the fluorochemical surface layer without the nanoparticles;
wherein the light transmissive substrate is adjacent the display panel.

20. The display device of claim 19, the display panel comprising a liquid crystal display panel, a plasma display panel, or a touch screen.
